(19) United States
(12) Patent Application Publication
(10) Pub. No.: US 2026/0059275 A1
(43) Pub. Date: Feb. 26, 2026

(54) POWER CONTROL FOR BISTATIC SENSING

(71) Applicant: QUALCOMM Incorporated, San Diego, CA (US)

(72) Inventors: Preeti KUMARI, San Diego, CA (US); Kapil GULATI, Belle Mead, NJ (US); Stelios STEFANATOS, San Diego, CA (US); Junyi LI, Greentown, PA (US); Shijun WU, San Diego, CA (US); Sony AKKARAKARAN, Poway, CA (US)

(21) Appl. No.: 19/151,159

(22) PCT Filed: Feb. 28, 2024
(86) PCT No.: PCT/US2024/017691

§ 371 Date: Jul. 25, 2025

(30) Foreign Application Priority Data
Mar. 27, 2023 (GR) 20230100254

(51) Int. Cl. H04W 4/38; G01S 13/00; H04W 52/24; H04W 52/36

(52) U.S. Cl. CPC H04W 4/38; G01S 13/003; H04W 52/243; H04W 52/367

(57) ABSTRACT

Various aspects of the present disclosure generally relate to wireless communication. In some aspects, a transmit (Tx) user equipment (UE) (Tx UE) may receive a resource grant identifying one or more resources for bistatic sensing with a receive (Rx) UE (Rx UE). The Tx UE may transmit, in the one or more resources identified in the resource grant, a sensing signal in accordance with one or more power specifications. The Tx UE may receive a configuration of a transmit power level, from among the one or more power specifications, for bistatic sensing with the Rx UE. Numerous other aspects are described.

### CROSS-REFERENCE TO RELATED APPLICATION

This Patent Application claims priority to Greek Patent Application No. 20230100254, filed on Mar. 27, 2023, entitled “POWER CONTROL FOR BISTATIC SENSING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for power control for bistatic sensing,

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a transmit (Tx) user equipment (UE) (Tx UE). The method may include receiving a resource grant identifying one or more resources for bistatic sensing with a receive (Rx) UE (Rx UE). The method may include transmitting, in the one or more resources identified in the resource grant, a sensing signal in accordance with one or more power specifications. The method may include receiving a configuration of a transmit power level, from among the one or more power specifications, for bistatic sensing with the Rx UE.

Some aspects described herein relate to a method of wireless communication performed by an Rx UE. The method may include receiving a resource grant identifying one or more resources for bistatic sensing with a Tx UE. The method may include receiving, in the one or more resources identified in the resource grant, a sensing signal in accordance with one or more power specifications. The method may include transmitting, to one or more of the Tx UE or a network entity associated with the Tx UE, an indication that a transmit power level of the sensing signal is above a threshold.

Some aspects described herein relate to a method of wireless communication performed by a network node. The method may include outputting or configuring a resource grant identifying one or more resources for bistatic sensing between a Tx UE and an Rx UE. The method may include outputting or configuring one or more power specifications to one or more of the Tx UE or the Rx UE. The method may include outputting or configuring a configuration of a transmit power level for the bistatic sensing between the Tx UE and the Rx UE.

Some aspects described herein relate to a Tx UE for wireless communication. The Tx UE may include a memory and one or more processors coupled to the memory. The one or more processors may be configured to receive a resource grant identifying one or more resources for bistatic sensing with an Rx UE. The one or more processors may be configured to transmit, in the one or more resources identified in the resource grant, a sensing signal in accordance with one or more power specifications. The one or more processors may be configured to receive a configuration of a transmit power level, from among the one or more power specifications, for bistatic sensing with the Rx UE.

Some aspects described herein relate to an Rx UE for wireless communication. The Rx UE may include a memory and one or more processors coupled to the memory. The one or more processors may be configured to receive a resource grant identifying one or more resources for bistatic sensing with a Tx UE. The one or more processors may be configured to receive, in the one or more resources identified in the resource grant, a sensing signal in accordance with one or more power specifications. The one or more processors may be configured to transmit, to one or more of the Tx UE or a network entity associated with the Tx UE, an indication that a transmit power level of the sensing signal is above a threshold.

Some aspects described herein relate to a network node for wireless communication. The network node may include a memory and one or more processors coupled to the memory. The one or more processors may be configured to output or configure a resource grant identifying one or more resources for bistatic sensing between a Tx UE and an Rx UE, The one or more processors may be configured to output or configure one or more power specifications to one or more of the Tx UE or the Rx UE. The one or more processors may be configured to output or configure a configuration of a transmit power level for the bistatic sensing between the Tx UE and the Rx UE.

Some aspects described herein relate to a non-transitory computer-readable medium that stores a set of instructions for wireless communication by a Tx UE. The set of instructions, when executed by one or more processors of the Tx UE, may cause the Tx UE to receive a resource grant identifying one or more resources for bistatic sensing with an Rx UE. The set of instructions, when executed by one or more processors of the Tx UE, may cause the Tx UE to transmit, in the one or more resources identified in the resource grant, a sensing signal in accordance with one or more power specifications. The set of instructions, when executed by one or more processors of the Tx UE, may cause the Tx UE to receive a configuration of a transmit power level, from among the one or more power specifications, for bistatic sensing with the Rx UE.

Some aspects described herein relate to a non-transitory computer-readable medium that stores a set of instructions for wireless communication by an Rx UE. The set of instructions, when executed by one or more processors of the Rx UE, may cause the Rx UE to receive a resource grant identifying one or more resources for bistatic sensing with a Tx UE. The set of instructions, when executed by one or more processors of the Rx UE, may cause the Rx UE to receive, in the one or more resources identified in the resource grant, a sensing signal in accordance with one or more power specifications. The set of instructions, when executed by one or more processors of the Rx UE, may cause the Rx UE to transmit, to one or more of the Tx UE or a network entity associated with the Tx UE, an indication that a transmit power level of the sensing signal is above a threshold.

Some aspects described herein relate to a non-transitory computer-readable medium that stores a set of instructions for wireless communication by a network node. The set of instructions, when executed by one or more processors of the network node, may cause the network node to output or configure a resource grant identifying one or more resources for bistatic sensing between a Tx UE and an Rx UE. The set of instructions, when executed by one or more processors of the network node, may cause the network node to output or configure one or more power specifications to one or more of the Tx UE or the Rx UE. The set of instructions, when executed by one or more processors of the network node, may cause the network node to output or configure a configuration of a transmit power level for the bistatic sensing between the Tx UE and the Rx UE.

Some aspects described herein relate to an apparatus for wireless communication. The apparatus may include means for receiving a resource grant identifying one or more resources for bistatic sensing with an Rx UE, The apparatus may include means for transmitting, in the one or more resources identified in the resource grant, a sensing signal in accordance with one or more power specifications, The apparatus may include means for receiving a configuration of a transmit power level, from among the one or more power specifications, for bistatic sensing with the Rx UE.

Some aspects described herein relate to an apparatus for wireless communication. The apparatus may include means for receiving a resource grant identifying one or more resources for bistatic sensing with a Tx UE. The apparatus may include means for receiving, in the one or more resources identified in the resource grant, a sensing signal in accordance with one or more power specifications. The apparatus may include means for transmitting, to one or more of the Tx UE or a network entity associated with the Tx UE, an indication that a transmit power level of the sensing signal is above a threshold.

Some aspects described herein relate to an apparatus for wireless communication. The apparatus may include means for outputting or configuring a resource grant identifying one or more resources for bistatic sensing between a Tx UE and an Rx UE. The apparatus may include means for outputting or configuring one or more power specifications to one or more of the Tx UE or the Rx UE. The apparatus may include means for outputting or configuring a configuration of a transmit power level for the bistatic sensing between the Tx UE and the Rx UE.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of scanning and tracking phases, in accordance with the present disclosure.

FIG. 5 is a diagram illustrating an example of bistatic sensing, in accordance with the present disclosure.

FIG. 6 is a diagram illustrating an example associated with power control for bistatic sensing, in accordance with the present disclosure.

FIG. 7 is a diagram illustrating an example process performed, for example, by a transmit (Tx) UE, in accordance with the present disclosure.

FIG. 8 is a diagram illustrating an example process performed, for example, by a receive (Rx) UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G)

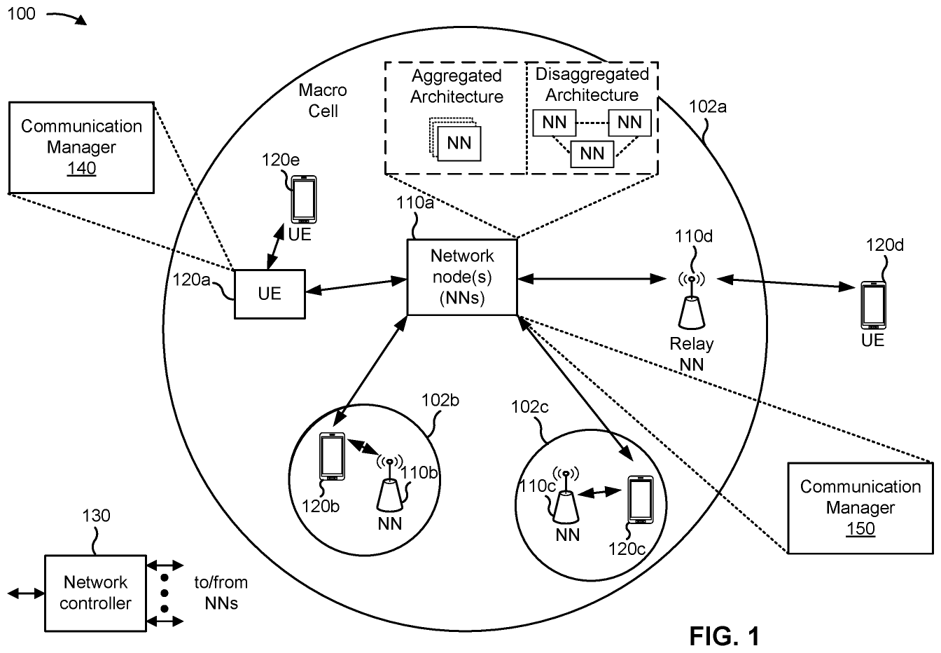

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave”band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, such when the UE 120 is a transmit (Tx) UE (Tx UE), the Tx UE 120 may include a communication manager 140. As described in more detail elsewhere herein, the communication manager 140 may receive a resource grant identifying one or more resources for bistatic sensing with a receive (Rx) UE (Rx UE); transmit, in the one or more resources identified in the resource grant, a sensing signal in accordance with one or more power specifications; and receive a configuration of a transmit power level, from among the one or more power specifications, for bistatic sensing with the Rx UE. Additionally, or alternatively, the communication manager 140 may perform one or more other operations described herein.

In some aspects, such as when the UE 120 is an Rx UE, as described in more detail elsewhere herein, the communication manager 140 may receive a resource grant identifying one or more resources for bistatic sensing with a Tx UE, receive, in the one or more resources identified in the resource grant, a sensing signal in accordance with one or more power specifications; and transmit, to one or more of the Tx UE or a network entity associated with the Tx UE, an indication that a transmit power level of the sensing signal is above a threshold. Additionally, or alternatively, the communication manager 140 may perform one or more other operations described herein.

In some aspects, the network node 110 may include a communication manager 150. As described in more detail elsewhere herein, the communication manager 150 may output or configure a resource grant identifying one or more resources for bistatic sensing between a Tx UE and an Rx UE; output or configure one or more power specifications to one or more of the Tx UE or the Rx UE; and output or configure a configuration of a transmit power level for the bistatic sensing between the Tx UE and the Rx UE. Additionally, or alternatively, the communication manager 150 may perform one or more other operations described herein.

As indicated above, FIG. 1 is provided as an example. Other examples may differ from what is described with regard to FIG. 1.

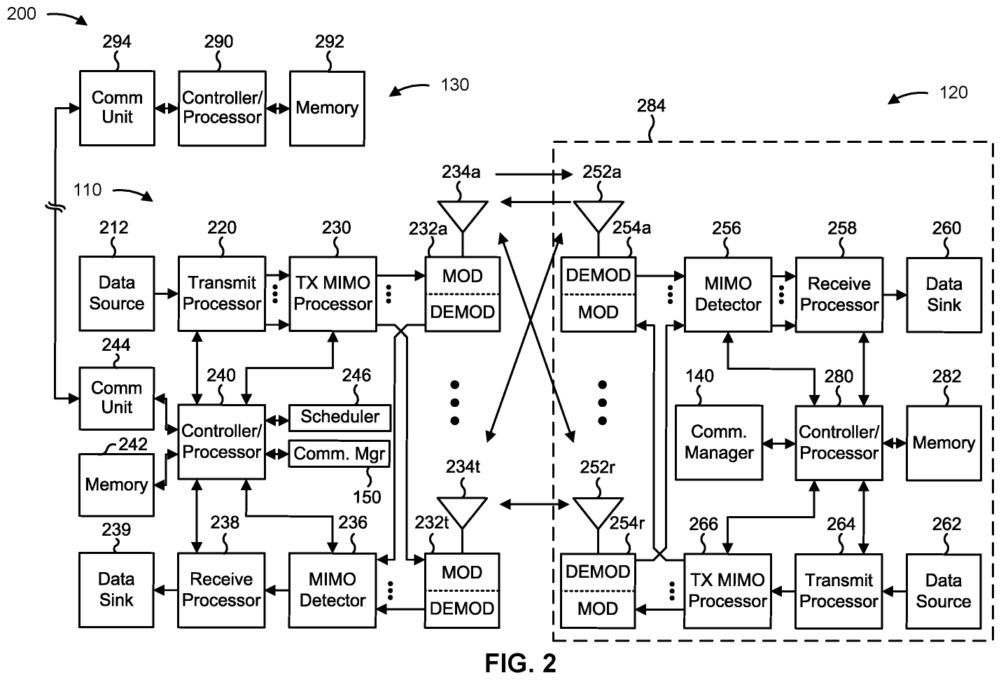

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

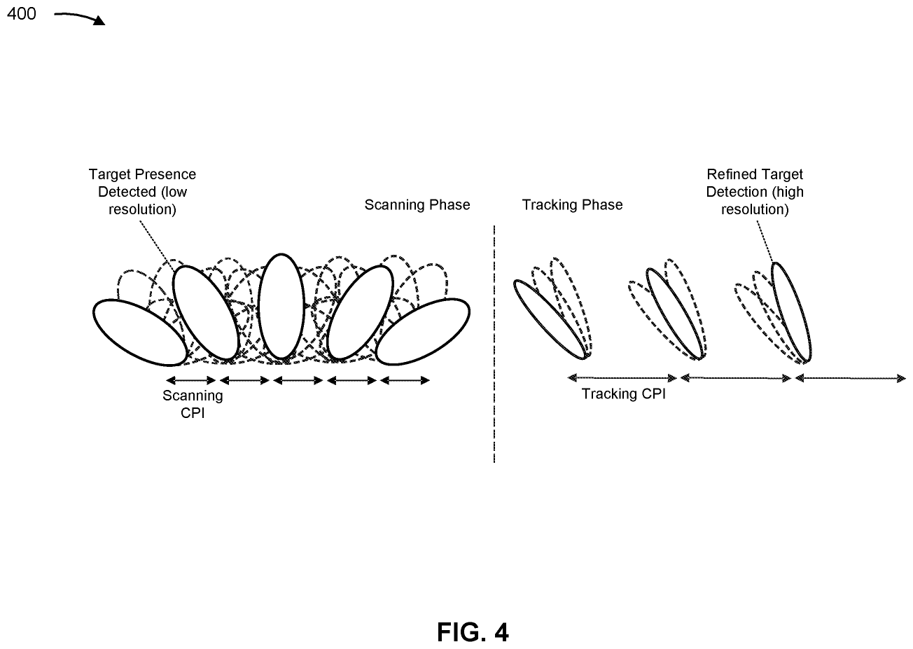

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DET-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications, In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

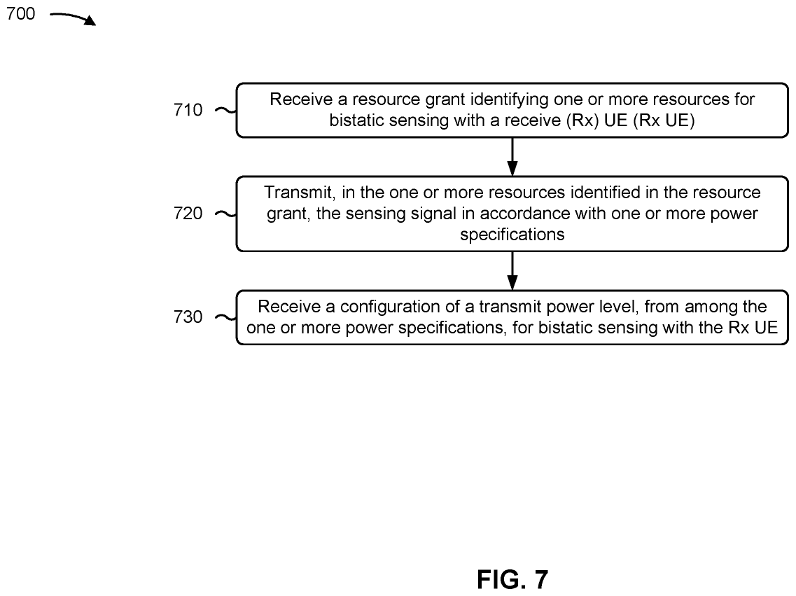

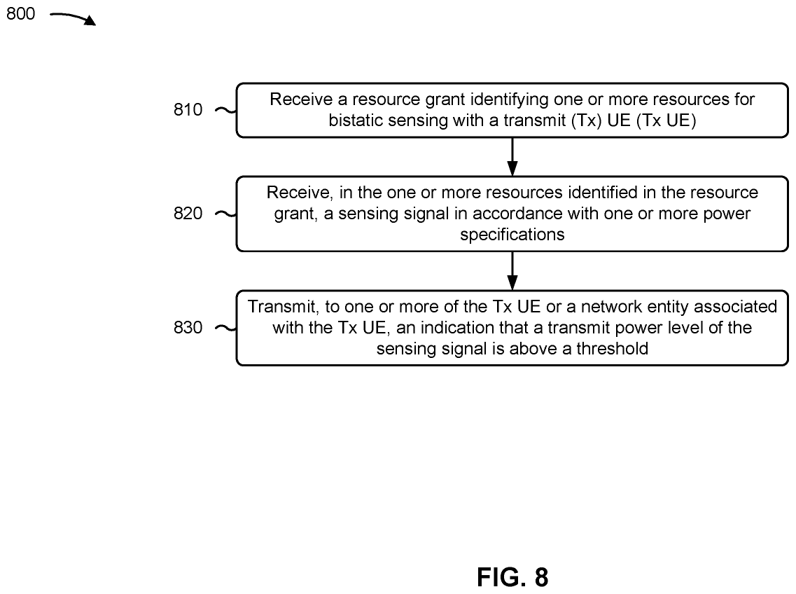

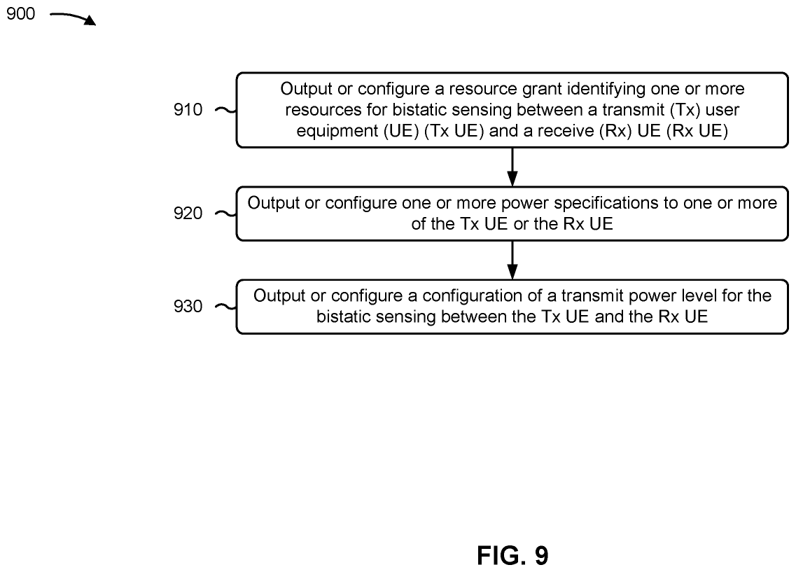

The controller/processor 240 of the network node 110, the controller/processor 280 of the UE 120, and/or any other component(s) of FIG. 2 may perform one or more techniques associated with bistatic sensing power control, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the Tx UE 120 includes means for receiving a resource grant identifying one or more resources for bistatic sensing with an Rx UE; means for transmitting, in the one or more resources identified in the resource grant, a sensing signal in accordance with one or more power specifications; and/or means for receiving a configuration of a transmit power level, from among the one or more power specifications, for bistatic sensing with the Rx UE. The means for the Tx UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the Rx UE 120 includes means for receiving a resource grant identifying one or more resources for bistatic sensing with a Tx UE; means for receiving, in the one or more resources identified in the resource grant, a sensing signal in accordance with one or more power specifications; and/or means for transmitting, to one or more of the Tx UE or a network entity associated with the Tx UE, an indication that a transmit power level of the sensing signal is above a threshold. The means for the Rx UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for outputting or configuring a resource grant identifying one or more resources for bistatic sensing between a Tx UE and an Rx UE; means for outputting or configuring one or more power specifications to one or more of the Tx UE or the Rx UE; and/or means for outputting or configuring a configuration of a transmit power level for the bistatic sensing between the Tx UE and the Rx UE, The means for the network node to perform operations described herein may include, for example, one or more of communication manager 150, transmit processor 220, TX MIMO processor 230, modem 232. antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

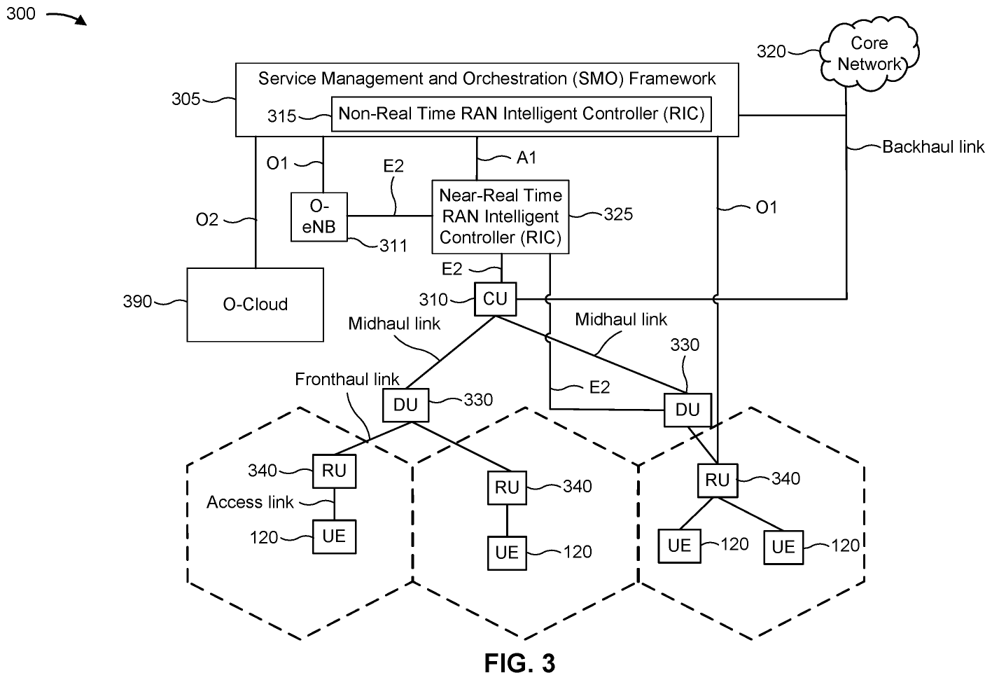

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of scanning and tracking phases, in accordance with the present disclosure.

Joint communication and radar (JCR) systems can be categorized as cooperative JCR systems or co-design JCR systems. In a cooperative JCR system, each UE has a radar transceiver (Tx/Rx) and a communication Tx/Rx. Information is shared between each radar Tx/Rx and each communication Tx/Rx, even among multiple UEs. Accordingly, the radar Tx/Rx of one UE may share information with the communication Tx/Rx of the same UE as well as with the radar Tx/Rx and/or the communication Tx/Rx of another UE. Moreover, the communication Tx/Rx of one UE may share information with the radar Tx/Rx of the same UE as well as with the radar Tx/Rx and/or the communication Tx/Rx of another UE. This approach generally allows spectrum reuse and ease of implementation. In a co-design JCR system, each UE includes a common transmitter or receiver used for both communication and radar functionality (called a JCR Tx/Rx). The JCR Tx/Rx of one UE may communicate with the JCR Tx/Rx of another UE. A benefit of this approach includes hardware and spectrum reuse.

In one example, vehicle UEs can use JCR systems to sense for surrounding objects. For example, to enable UE-side JCR sensing, uplink (UL) resources can be used for both communication and sensing. In one aspect, separate resources may be allocated for communication and radar modes. For instance, a sounding reference signal (SRS) can be used as a sensing waveform. In one aspect, the same resource can be used for both communication and radar with a joint-co-design waveform.

One way to share UL resources during scanning and tracking is with two-stage sensing illustrated in FIG. 4. As shown, a scanning phase occurs prior to a tracking phase. During both the scanning phase and the tracking phase, the vehicle UE may output multiple beams in different directions. The beams output during the scanning phase (i.e., “scanning beams”) may have a lower resolution than the beams output during the tracking phase (i.e., “tracking beams”). For example, the scanning beams may have a coherent processing interval (CPI), also referred to as the radar frame, of 1 ms, a bandwidth of 150 MHz, and a subcarrier spacing (SCS) of 120 kHz. The tracking beams may be higher resolution than the scanning beams. For instance, the tracking beams may have a CPI of 5 ms and a bandwidth of 0.5 GHz. Further, the directions of the tracking beams may be based at least in part on the presence of targets identified by the scanning beams. For example, the tracking beams may be output toward one or more targets identified by the scanning beam. Therefore, in some aspects, the vehicle UE may output fewer tracking beams than scanning beams in a single scanning and tracking phase.

As indicated above, FIG. 4 is provided as an example. Other examples may differ from what is described with respect to FIG. 4.

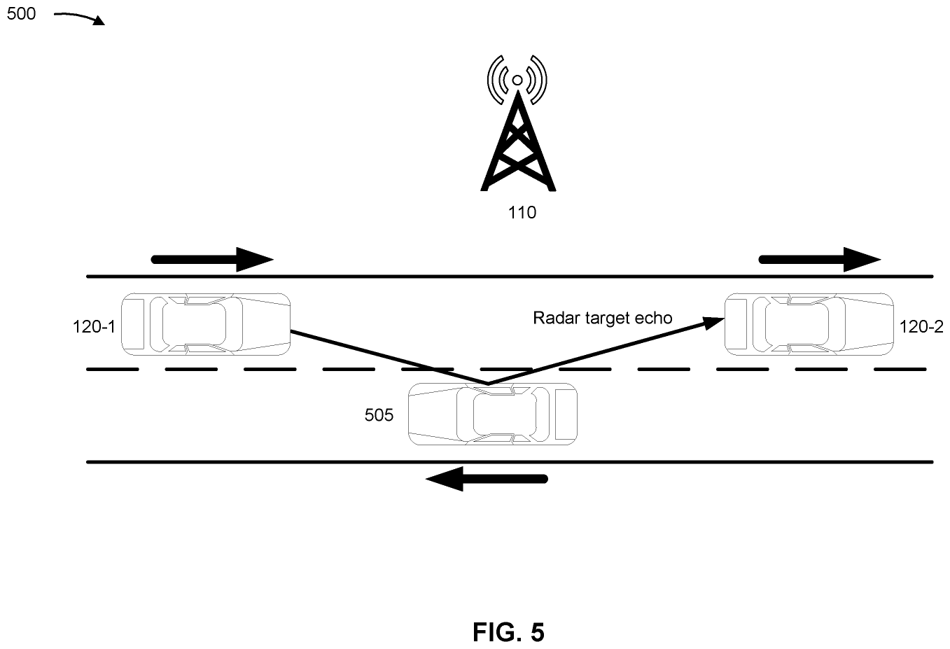

FIG. 5 is a diagram illustrating an example 500 of bistatic sensing, in accordance with the present disclosure. Bistatic sensing refers to a form of JCR where the Tx/Rx pairs are separated. In the example 500, the Tx/Rx pair are on different vehicle UEs 120. For example, the Tx/Rx transceiver of a first vehicle UE 120-1 may transmit a sensing waveform and/or tracking waveform, and the Tx/Rx transceiver of a second vehicle UE 120-2 may receive the sensing waveform and/or tracking waveform.

In the example 500, a target object 505 (shown as a vehicle) is located between the first vehicle UE 120-1 and the second vehicle UE 120-2. The target object 505 may be detected by the first vehicle UE 120-1 and/or the second vehicle UE 120-2. For example, the first vehicle UE 120-1 may transmit, using the JCR Tx/Rx of the first vehicle UE 120-1, a beam during the sensing phase toward the target object 505. The beam may reflect off the target object 505 toward the second vehicle UE 120-2, which may receive the beam using the JCR Tx/Rx of the second vehicle 120-2. Based on various factors such as the speed of the first vehicle UE 120-1, the speed of the second vehicle UE 120-2, a combination thereof, and/or the like, the speed and/or location of the target object 505 may be determined by the second vehicle UE 120-2. The second vehicle UE 120-2 may transmit, using the JCR Tx/Rx of the second vehicle UE 120-2, a communication to the first vehicle UE indicating the speed and/or location of the target object 505. In some instances, the communication may indicate the speed of the second vehicle UE 120-2 and/or information about the beam received by the JCR Tx/Rx of the second vehicle UE 120-2. The first vehicle UE 120-1 may use the information included in the communication from the second vehicle UE 120-2 to determine the location and/or speed of the target object 505.

As indicated above, FIG. 5 is provided as an example. Other examples may differ from what is described with respect to FIG. 5.

Bistatic sensing services using Tx UEs on uplink or sidelink resources may be constrained by limited transmit power. For example, the transmit power of the UE may be limited for UL communications. Additionally or in the alternative, even if the UE is configured for high-powered UL transmissions, a large transmit power can lead to significant interference. Accordingly, UEs need to be able to perform bistatic sensing services for high radar detection and estimation performance at lower transmit powers. Further, UEs are not always configured for power control for bistatic sensing, even in instances where the UE is configured for power control for bistatic communication.

Some techniques and apparatuses described herein enable a Tx UE to receive a resource grant identifying one or more resources for bistatic sensing with an Rx UE; transmit, in the one or more resources identified in the resource grant, a sensing signal in accordance with one or more power specifications; and receive a configuration of a transmit power level, from among the one or more power specifications, for bistatic sensing with the Rx UE. As a result, the Tx UE may be configured for power control for bistatic sensing. Moreover, the transmit power may be optimized and adjusted to increase radar performance.

Some techniques and apparatuses described herein enable an Rx UE to receive a resource grant identifying one or more resources for bistatic sensing with a Tx UE; receive, in the one or more resources identified in the resource grant, a sensing signal in accordance with one or more power specifications; and transmit, to one or more of the Tx UE or a network entity associated with the Tx UE, an indication that a transmit power level of the sensing signal is above a threshold. Accordingly, the Rx UE may identify and apply an optimized transmission power level for bistatic sensing with the Tx UE.

Some techniques and apparatuses described herein enable a network entity to output or configure a resource grant identifying one or more resources for bistatic sensing between a Tx UE and an Rx UE; output or configure one or more power specifications to one or more of the Tx UE or the Rx UE; and output or configure a configuration of a transmit power level for the bistatic sensing between the Tx UE and the Rx UE. As a result, the network entity can configure the UE to optimize and adjust the transmit power during bistatic sensing services in a way that increases radar performance without significantly increasing network interference that negatively impacts network performance.

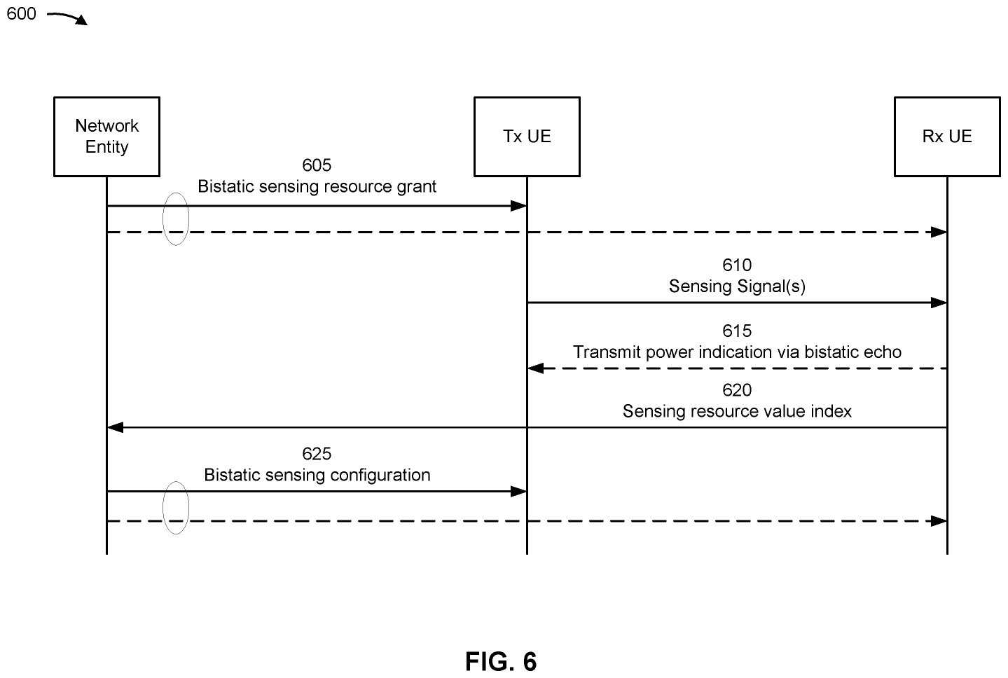

FIG. 6 is a diagram illustrating an example 600 associated with power control for bistatic sensing, in accordance with the present disclosure. As shown in FIG. 6, a network entity (e.g., network node 110), a Tx UE (e.g., UE 120, such as UE 120-1), and an Rx UE (e.g., UE 120, such as UE 120-2) may communicate with one another.

As shown by reference number 605, the network entity may transmit, and the Tx UE may receive, a resource grant identifying one or more resources for bistatic sensing with the Rx UE. The resource grant may indicate times and/or frequencies allocated to bistatic sensing services between the Tx UE and the Rx UE. In some aspects, the resource grant may further indicate power specifications (discussed below) for the sensing signals. In some aspects, the Rx UE may also receive the resource grant.

As shown by reference number 610, the Tx UE may transmit, and the Rx UE may receive, one or more sensing signals in accordance with one or more power specifications. In some aspects, the power specifications are received, by the Tx UE, from the Rx UE. In some aspects, the sensing signals at reference number 610 correspond to scanning signals during the scanning phase of the bistatic sensing service. In some aspects, the power specifications may include one or more of a minimum transmission power, a step power, a maximum power, and/or a combination thereof, among other examples. In some aspects, the Tx UE may transmit, and the Rx UE may receive, a first iteration of the sensing signal and a second iteration of the sensing signal. The first iteration may be transmitted by the Tx UE at the minimum transmission power, and the second iteration of the sensing signal may be transmitted by the Tx UE at a higher power level than the power level of the first iteration. For example, the power level of the second iteration may be a value equal to the power level of the first iteration (i.e., the minimum transmission power) increased by the step power. In some aspects, the Tx UE may transmit the first iteration of the sensing signal at the maximum transmission power and transmit the second iteration of the sensing signal at a lower power level. In this example, the transmission power of the second iteration may be the power level of the first iteration (e.g., the maximum transmission power) decreased by the step power.

As shown by reference number 615, the Rx UE may transmit, and the Tx UE may receive, a bistatic echo including transmit power information about the signals transmitted at reference number 610. In some aspects, the transmit power information may indicate one or more sensing signals transmitted at reference number 610 that meet or exceed a predetermined threshold. In some aspects, different iterations of signals are transmitted from the Rx UE to the Tx UE at different power levels. The Tx UE, the network entity, and/or a combination of both, may use the transmit power information to determine which transmit power levels are appropriate for bistatic sensing between the Tx UE and the Rx UE. In some aspects, the Rx UE may determine a performance metric associated with one or more of the first iteration of the sensing signal, the second iteration of the sensing signal, and/or a combination thereof, among other examples. In some aspects, the performance metric may include an indication of the number of targets detected. In some aspects, the performance metric is defined, at least in part, by a difference between two intersection over union (IoU) values. In some aspects, the performance metric may be defined, at least in part, by a difference between IoU values relative to an IoU gradient threshold. In some aspects, the performance metric may be defined, at least in part, by a minimum IoU among one or more of the detected targets. In some aspects, the performance metric may include a minimum signal-to-interference-plus-noise ratio (SINR). In some aspects, the performance metric may be defined, at least in part, by a target SINR gradient. In some aspects, the performance metric may indicate the number of detected targets. In some aspects, the performance metric may be based, at least in part, on a negative mean square error (MSE) gradient of one or more of a range, velocity, angle, or amplitude estimation of the detected target. In some aspects, the performance metric may be determined based, at least in part, on the first iteration of the sensing signal and the second iteration of the sensing signal. In some aspects, the performance metric may be based, at least in part, on a number of bounding boxes detected. In some aspects, the performance metric may include a radar sensing resolution. In some aspects, the performance metric may include a maximum range associated with the first iteration of the sensing signal, a maximum range associated with the second iteration of the sensing signal, and/or a combination thereof, among other examples.

In some aspects, performance metrics to determine the transmit power may include low level sensing metrics such as one or more of a reference signal received power (RSRP), an SINR (or total SINR), an interference to noise ratio (INR) (or total INR), a total interference power, an RSRP path corresponding to an mth delay of the channel response, an SINR path corresponding to the mth delay of the channel response, a target RSRP path or a target SINR path (corresponding to a kth detected target in a range-angle-Doppler grid), or an interference power statistic or a clutter power statistic (such as an average or 50^{th} percentile or maximum) for a given set of range-angle-Doppler cells. In some aspects, high-level sensing metrics (such as IoU) to be met may be specified by the network node 110 along with an optional mapping rule to convert high-level sensing to low-level sensing metrics. In some aspects, the criteria to decide transmit power may be based on the threshold for a given sensing metric at a given iteration with a corresponding power. In some aspects, the criteria to determine transmit power may be based on a difference between the sensing metric value in a previous (e.g., the most recent or another earlier) iteration. If the difference is below a threshold, then the Rx UE may report to the network node 110 with the optimal power as the transmit power level of the previous iteration.

In some aspects, the Tx UE may determine the optimal transmit power where the received power was sufficient for its sensing purpose, and report the transmit power to the network node. In some aspects, the Rx UE may inform the Tx UE which performance metric or criteria may be used for determining optimal transmit power. In some aspects, the Rx UE may informs the Tx UE about which targets to prioritize or discard while determining the optimal transmit power. For example, Rx UE may prefer information about targets close to the location of the Rx UE rather than information about the targets close to the location of the Tx UE.

As shown by reference number 620, the Rx UE may transmit, and the network entity may receive, a sensing resource value index. The sensing resource value index may identify which of the sensing signals can be used for bistatic sensing between the Tx UE and the Rx UE. For example, the sensing resource value index may indicate which of the sensing signals was received by the Rx UE at or above a predetermined threshold.

As shown by reference number 625, the network entity may transmit, and the Tx UE and/or the Rx UE may receive, the bistatic sensing configuration. In some aspects, the bistatic sensing configuration may be based, at least in part, on the sensing resource value index transmitted by the Rx UE. The bistatic sensing configuration may indicate the transmit power level for bistatic sensing signals used during the tracking phase of the bistatic sensing service. With the bistatic sensing configuration, the Tx UE and the Rx UE can proceed to the tracking phase of the bistatic sensing service. The signals transmitted during the tracking phase may be at the power levels indicated by the bistatic sensing configuration.

Accordingly, the Tx UE and the Rx UE can be configured to transmit bistatic sensing signals at optimized power levels, resulting in reduced network interference and increased radar performance.

As indicated above, FIG. 6 is provided as an example. Other examples may differ from what is described with respect to FIG. 6.

FIG. 7 is a diagram illustrating an example process 700 performed, for example, by a Tx UE, in accordance with the present disclosure. Example process 700 is an example where the Tx UE (e.g., Tx UE 120-1 of FIG. 5) performs operations associated with power control for bistatic sensing.

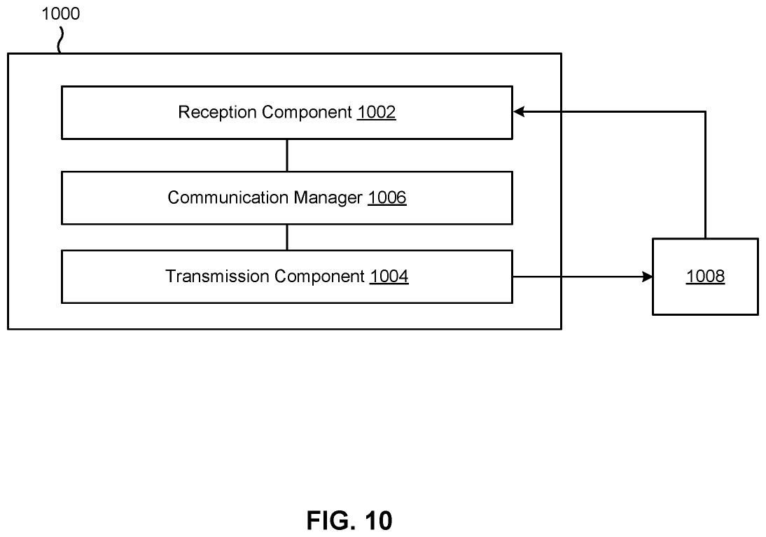

As shown in FIG. 7, in some aspects, process 700 may include receiving a resource grant identifying one or more resources for bistatic sensing with an Rx UE (block 710). For example, the Tx UE (e.g., using reception component 1002 and/or communication manager 1006, depicted in FIG. 10) may receive a resource grant identifying one or more resources for bistatic sensing with an Rx UE, as described above.

As further shown in FIG. 7, in some aspects, process 700 may include transmitting, in the one or more resources identified in the resource grant, a sensing signal in accordance with one or more power specifications (block 720). For example, the Tx UE (e.g., using transmission component 1004 and/or communication manager 1006, depicted in FIG. 10) may transmit, in the one or more resources identified in the resource grant, a sensing signal in accordance with one or more power specifications, as described above.

As further shown in FIG. 7, in some aspects, process 700 may include receiving a configuration of a transmit power level, from among the one or more power specifications, for bistatic sensing with the Rx UE (block 730), For example, the Tx UE (e.g., using reception component 1002 and/or communication manager 1006, depicted in FIG. 10) may receive a configuration of a transmit power level, from among the one or more power specifications, for bistatic sensing with the Rx UE, as described above.

Process 700 may include additional aspects, such as any single aspect or any combination of aspects described below and/or in connection with one or more other processes described elsewhere herein.

In a first aspect, process 700 includes receiving, from the Rx UE, an indication that the transmit power level of the sensing signal is above a threshold value.

In a second aspect, alone or in combination with the first aspect, the one or more power specifications include one or more of a minimum transmission power, a step power, or a maximum transmission power.

In a third aspect, alone or in combination with one or more of the first and second aspects, transmitting the sensing signal in accordance with the one or more power specifications includes transmitting a first iteration of the sensing signal at the minimum transmission power and transmitting a second iteration of the sensing signal, and a power of the second iteration of the sensing signal is increased by the step power relative to the minimum transmission power of the first iteration of the sensing signal.

In a fourth aspect, alone or in combination with one or more of the first through third aspects, transmitting the sensing signal in accordance with the one or more power specifications includes transmitting a first iteration of the sensing signal at the maximum transmission power and transmitting a second iteration of the sensing signal, and a power of the second iteration of the sensing signal is decreased by the step power relative to the maximum transmission power of the first iteration of the sensing signal.

In a fifth aspect, alone or in combination with one or more of the first through fourth aspects, process 700 includes receiving a bistatic sensing echo, and determining the one or more power specifications based at least in part on the bistatic sensing echo received.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by an Rx UE, in accordance with the present disclosure. Example process 800 is an example where the Rx UE (e.g., Rx UE 120-2 of FIG. 5) performs operations associated with power control for bistatic sensing.

As shown in FIG. 8, in some aspects, process 800 may include receiving a resource grant identifying one or more resources for bistatic sensing with a Tx UE (block 810). For example, the Rx UE (e.g., using reception component 1002 and/or communication manager 1006, depicted in FIG. 10) may receive a resource grant identifying one or more resources for bistatic sensing with a Tx UE, as described above.

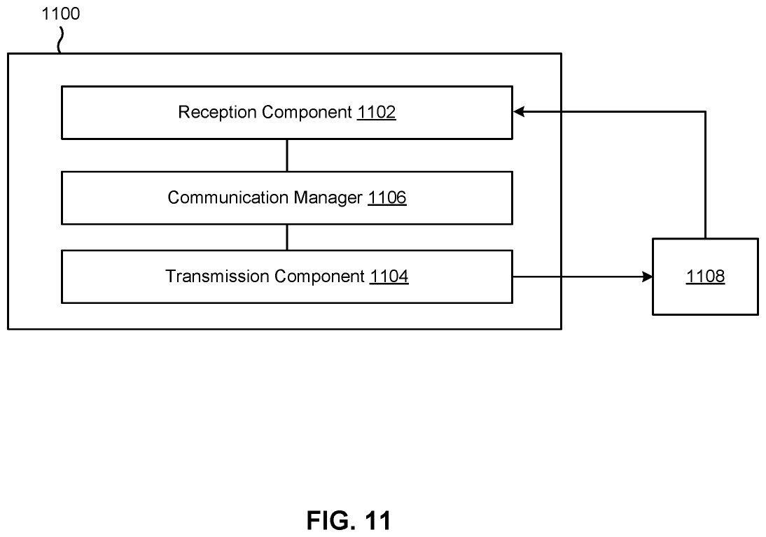

As further shown in FIG. 8, in some aspects, process 800 may include receiving, in the one or more resources identified in the resource grant, a sensing signal in accordance with one or more power specifications (block 820). For example, the Rx UE (e.g., using reception component 1102 and/or communication manager 1106, depicted in FIG. 11) may receive, in the one or more resources identified in the resource grant, a sensing signal in accordance with one or more power specifications, as described above.

As further shown in FIG. 8, in some aspects, process 800 may include transmitting, to one or more of the Tx UE or a network entity associated with the Tx UE, an indication that a transmit power level of the sensing signal is above a threshold (block 830). For example, the Rx UE (e.g., using transmission component 1104 and/or communication manager 1106, depicted in FIG. 11) may transmit, to one or more of the Tx UE or a network entity associated with the Tx UE, an indication that a transmit power level of the sensing signal is above a threshold, as described above.

Process 800 may include additional aspects, such as any single aspect or any combination of aspects described below and/or in connection with one or more other processes described elsewhere herein.

In a first aspect, the one or more power specifications include one or more of a minimum transmission power, a step power, or a maximum transmission power.

In a second aspect, alone or in combination with the first aspect, receiving the sensing signal in accordance with the one or more power specifications includes receiving a first iteration of the sensing signal at the minimum transmission power and receiving a second iteration of the sensing signal, and a power of the second iteration of the sensing signal is increased by the step power relative to the minimum transmission power of the first iteration of the sensing signal.

In a third aspect, alone or in combination with one or more of the first and second aspects, process 800 includes determining a performance metric of one or more of the first iteration of the sensing signal or the second iteration of the sensing signal.

In a fourth aspect, alone or in combination with one or more of the first through third aspects, the performance metric includes an indication of a number of detected targets.

In a fifth aspect, alone or in combination with one or more of the first through fourth aspects, the performance metric includes a difference between two IoU values.

In a sixth aspect, alone or in combination with one or more of the first through fifth aspects, the performance metric includes a difference between IoU values relative to an IoU gradient threshold.

In a seventh aspect, alone or in combination with one or more of the first through sixth aspects, the performance metric includes a minimum IoU among one or more detected targets.

In an eighth aspect, alone or in combination with one or more of the first through seventh aspects, the performance metric includes a minimum SINR.

In a ninth aspect, alone or in combination with one or more of the first through eighth aspects, the performance metric includes a target SINR gradient.

In a tenth aspect, alone or in combination with one or more of the first through ninth aspects, the performance metric includes a number of new detected targets.

In an eleventh aspect, alone or in combination with one or more of the first through tenth aspects, the performance metric includes a negative of MSE of one or more of a range, velocity, angle, or amplitude estimation of a detected target.

In a twelfth aspect, alone or in combination with one or more of the first through eleventh aspects, the performance metric includes a negative MSE gradient of one or more of a range, velocity, angle, or amplitude estimation of a detected target.

In a thirteenth aspect, alone or in combination with one or more of the first through twelfth aspects, the performance metric includes one or more of an RSRP, an SINR, an INR, a total interference power, an RSRP path, an SINR path, a target RSRP path, a target SINR path, an interference power statistic, or a clutter power statistic.

In a fourteenth aspect, alone or in combination with one or more of the first through thirteenth aspects, receiving the sensing signal in accordance with the one or more power specifications includes receiving a first iteration of the sensing signal at the maximum transmission power and receiving a second iteration of the sensing signal, and a power of the second iteration of the sensing signal is decreased by the step power relative to the maximum transmission power of the first iteration of the sensing signal.

In a fifteenth aspect, alone or in combination with one or more of the first through fourteenth aspects, process 800 includes determining a performance metric of one or more of the first iteration of the sensing signal or the second iteration of the sensing signal.

In a sixteenth aspect, alone or in combination with one or more of the first through fifteenth aspects, the performance metric includes a number of bounding boxes detected.

In a seventeenth aspect, alone or in combination with one or more of the first through sixteenth aspects, the performance metric includes a radar sensing resolution.

In an eighteenth aspect, alone or in combination with one or more of the first through seventeenth aspects, the performance metric includes a maximum range associated with the first iteration of the sensing signal or the second iteration of the sensing signal.

In a nineteenth aspect, alone or in combination with one or more of the first through eighteenth aspects, process 800 includes receiving the one or more power specifications.

In a twentieth aspect, alone or in combination with one or more of the first through nineteenth aspects, process 800 includes transmitting a bistatic sensing echo in response to the sensing signal and in accordance with the one or more power specifications.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with power control for bistatic sensing.

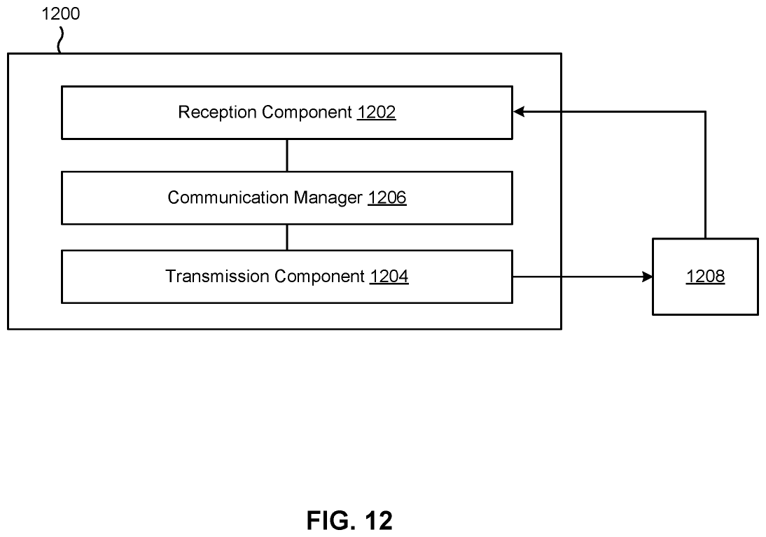

As shown in FIG. 9, in some aspects, process 900 may include outputting or configuring a resource grant identifying one or more resources for bistatic sensing between a Tx UE and an Rx UE (block 910). For example, the network node (e.g., using transmission component 1204 and/or communication manager 1206, depicted in FIG. 12) may output or configure a resource grant identifying one or more resources for bistatic sensing between a Tx UE and an Rx UE, as described above.

As further shown in FIG. 9, in some aspects, process 900 may include outputting or configuring one or more power specifications to one or more of the Tx UE or the Rx UE (block 920). For example, the network node (e.g., using transmission component 1204 and/or communication manager 1206, depicted in FIG. 12) may output or configure one or more power specifications to one or more of the Tx UE or the Rx UE, as described above.

As further shown in FIG. 9, in some aspects, process 900 may include outputting or configuring a configuration of a transmit power level for the bistatic sensing between the Tx UE and the Rx UE (block 930). For example, the network node (e.g., using transmission component 1204 and/or communication manager 1206, depicted in FIG. 12) may output or configure a configuration of a transmit power level for the bistatic sensing between the Tx UE and the Rx UE, as described above.

Process 900 may include additional aspects, such as any single aspect or any combination of aspects described below and/or in connection with one or more other processes described elsewhere herein.

In a first aspect, the one or more power specifications include one or more of a minimum transmission power, a step power, or a maximum transmission power.

In a second aspect, alone or in combination with the first aspect, process 900 includes determining a performance metric of one or more of a first iteration of a sensing signal or a second iteration of a sensing signal transmitted between the Tx UE and the Rx UE.

In a third aspect, alone or in combination with one or more of the first and second aspects, the performance metric includes an indication of a number of detected targets.

In a fourth aspect, alone or in combination with one or more of the first through third aspects, the performance metric includes a difference between two IoU values.

In a fifth aspect, alone or in combination with one or more of the first through fourth aspects, the performance metric includes a difference between IoU values relative to an IoU gradient threshold.

In a sixth aspect, alone or in combination with one or more of the first through fifth aspects, the performance metric includes a minimum IoU among detected targets.

In a seventh aspect, alone or in combination with one or more of the first through sixth aspects, the performance metric includes a minimum SINR.

In an eighth aspect, alone or in combination with one or more of the first through seventh aspects, the performance metric includes a target SINR gradient.

In a ninth aspect, alone or in combination with one or more of the first through eighth aspects, the performance metric includes a number of new detected targets.

In a tenth aspect, alone or in combination with one or more of the first through ninth aspects, the performance metric includes a negative of MSE of one or more of a range, velocity, angle, or amplitude estimation of a detected target.

In an eleventh aspect, alone or in combination with one or more of the first through tenth aspects, the performance metric includes a negative MSE gradient of one or more of a range, velocity, angle, or amplitude estimation of a detected target.

In a twelfth aspect, alone or in combination with one or more of the first through eleventh aspects, the performance metric includes one or more of an RSRP, an SINR, an INR, a total interference power, an RSRP path, an SINR path, a target RSRP path, a target SINR path, an interference power statistic, or a clutter power statistic.

In a thirteenth aspect, alone or in combination with one or more of the first through twelfth aspects, the performance metric includes a number of bounding boxes detected.

In a fourteenth aspect, alone or in combination with one or more of the first through thirteenth aspects, the performance metric includes a radar sensing resolution.

In a fifteenth aspect, alone or in combination with one or more of the first through fourteenth aspects, the performance metric includes a maximum range associated with the first iteration of the sensing signal or the second iteration of the sensing signal.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a Tx UE, or a Tx UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-6. Additionally, or alternatively, the apparatus 1000 may be configured to perform one or more processes described herein, such as process 700 of FIG. 7. In some aspects, the apparatus 1000 and/or one or more components shown in FIG. 10 may include one or more components of the Tx UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the Tx UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the Tx UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a resource grant identifying one or more resources for bistatic sensing with an Rx UE. The transmission component 1004 may transmit, in the one or more resources identified in the resource grant, a sensing signal in accordance with one or more power specifications. The reception component 1002 may receive a configuration of a transmit power level, from among the one or more power specifications, for bistatic sensing with the Rx UE.

The reception component 1002 may receive, from the Rx UE, an indication that the transmit power level of the sensing signal is above a threshold value. The reception component 1002 may receive a bistatic sensing echo.

The communication manager 1006 may determine the one or more power specifications based at least in part on the bistatic sensing echo received.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be an Rx UE, or an Rx UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-6. Additionally, or alternatively, the apparatus 1100 may be configured to perform one or more processes described herein, such as process 800 of FIG. 8. In some aspects, the apparatus 1100 and/or one or more components shown in FIG. 11 may include one or more components of the Rx UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the Rx UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the Rx UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a resource grant identifying one or more resources for bistatic sensing with a Tx UE. The reception component 1102 may receive, in the one or more resources identified in the resource grant, a sensing signal in accordance with one or more power specifications. The transmission component 1104 may transmit, to one or more of the Tx UE or a network entity associated with the Tx UE, an indication that a transmit power level of the sensing signal is above a threshold.

The communication manager 1106 may determine a performance metric of one or more of the first iteration of the sensing signal or the second iteration of the sensing signal. The communication manager 1106 may determine a performance metric of one or more of the first iteration of the sensing signal or the second iteration of the sensing signal.

The reception component 1102 may receive the one or more power specifications.

The transmission component 1104 may transmit a bistatic sensing echo in response to the sensing signal and in accordance with the one or more power specifications.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-6. Additionally, or alternatively, the apparatus 1200 may be configured to perform one or more processes described herein, such as process 900 of FIG. 9. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may output or configure a resource grant identifying one or more resources for bistatic sensing between a Tx UE and an Rx UE. The transmission component 1204 may output or configure one or more power specifications to one or more of the Tx UE or the Rx UE. The transmission component 1204 may output or configure a configuration of a transmit power level for the bistatic sensing between the Tx UE and the Rx UE.

The communication manager 1206 may determine a performance metric of one or more of a first iteration of a sensing signal or a second iteration of a sensing signal transmitted between the Tx UE and the Rx UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a Tx UE, comprising: receiving a resource grant identifying one or more resources for bistatic sensing with an Rx UE; transmitting, in the one or more resources identified in the resource grant, a sensing signal in accordance with one or more power specifications; and receiving a configuration of a transmit power level, from among the one or more power specifications, for bistatic sensing with the Rx UE.

Aspect 2: The method of Aspect 1, further comprising receiving, from the Rx UE, an indication that the transmit power level of the sensing signal is above a threshold value.

Aspect 3: The method of any of Aspects 1-2, wherein the one or more power specifications include one or more of a minimum transmission power, a step power, or a maximum transmission power.

Aspect 4: The method of Aspect 3, wherein transmitting the sensing signal in accordance with the one or more power specifications includes transmitting a first iteration of the sensing signal at the minimum transmission power and transmitting a second iteration of the sensing signal, wherein a power of the second iteration of the sensing signal is increased by the step power relative to the minimum transmission power of the first iteration of the sensing signal.

Aspect 5: The method of Aspect 3, wherein transmitting the sensing signal in accordance with the one or more power specifications includes transmitting a first iteration of the sensing signal at the maximum transmission power and transmitting a second iteration of the sensing signal, wherein a power of the second iteration of the sensing signal is decreased by the step power relative to the maximum transmission power of the first iteration of the sensing signal.

Aspect 6: The method of any of Aspects 1-5, further comprising: receiving a bistatic sensing echo; and determining the one or more power specifications based at least in part on the bistatic sensing echo received.

Aspect 7: A method of wireless communication performed by an Rx UE, comprising: receiving a resource grant identifying one or more resources for bistatic sensing with a Tx UE; receiving, in the one or more resources identified in the resource grant, a sensing signal in accordance with one or more power specifications; and transmitting, to one or more of the Tx UE or a network entity associated with the Tx UE, an indication that a transmit power level of the sensing signal is above a threshold.

Aspect 8: The method of Aspect 7, wherein the one or more power specifications include one or more of a minimum transmission power, a step power, or a maximum transmission power.

Aspect 9: The method of Aspect 8, wherein receiving the sensing signal in accordance with the one or more power specifications includes receiving a first iteration of the sensing signal at the minimum transmission power and receiving a second iteration of the sensing signal, wherein a power of the second iteration of the sensing signal is increased by the step power relative to the minimum transmission power of the first iteration of the sensing signal.

Aspect 10: The method of Aspect 9, further comprising determining a performance metric of one or more of the first iteration of the sensing signal or the second iteration of the sensing signal.

Aspect 11: The method of Aspect 10, wherein the performance metric includes an indication of a number of detected targets.

Aspect 12: The method of Aspect 10, wherein the performance metric includes a difference between two IoU values.

Aspect 13: The method of Aspect 10, wherein the performance metric includes a difference between IoU values relative to an IoU gradient threshold.

Aspect 14: The method of Aspect 10, wherein the performance metric includes a minimum IoU among one or more detected targets.

Aspect 15: The method of Aspect 10, wherein the performance metric includes a minimum SINR.

Aspect 16: The method of Aspect 10, wherein the performance metric includes a target SINR gradient.

Aspect 17: The method of Aspect 10, wherein the performance metric includes a number of new detected targets.

Aspect 18: The method of Aspect 10, wherein the performance metric includes a negative of MSE of one or more of a range, velocity, angle, or amplitude estimation of a detected target.

Aspect 19: The method of Aspect 10, wherein the performance metric includes a negative MSE gradient of one or more of a range, velocity, angle, or amplitude estimation of a detected target.

Aspect 20: The method of Aspect 10, wherein the performance metric includes one or more of an RSRP, an SINR, an INR, a total interference power, an RSRP path, an SINR path, a target RSRP path, a target SINR path, an interference power statistic, or a clutter power statistic.

Aspect 21: The method of Aspect 8, wherein receiving the sensing signal in accordance with the one or more power specifications includes receiving a first iteration of the sensing signal at the maximum transmission power and receiving a second iteration of the sensing signal, wherein a power of the second iteration of the sensing signal is decreased by the step power relative to the maximum transmission power of the first iteration of the sensing signal.

Aspect 22: The method of Aspect 21, further comprising determining a performance metric of one or more of the first iteration of the sensing signal or the second iteration of the sensing signal.

Aspect 23: The method of Aspect 22, wherein the performance metric includes a number of bounding boxes detected.

Aspect 24: The method of Aspect 22, wherein the performance metric includes a radar sensing resolution.

Aspect 25: The method of Aspect 22, wherein the performance metric includes a maximum range associated with the first iteration of the sensing signal or the second iteration of the sensing signal.

Aspect 26: The method of any of Aspects 7-25, further comprising receiving the one or more power specifications.

Aspect 27: The method of Aspect 26, further comprising transmitting a bistatic sensing echo in response to the sensing signal and in accordance with the one or more power specifications.

Aspect 28: A method of wireless communication performed by a network node, comprising: outputting or configuring a resource grant identifying one or more resources for bistatic sensing between a Tx UE and an Rx UE; outputting or configuring one or more power specifications to one or more of the Tx UE or the Rx UE; and outputting or configuring a configuration of a transmit power level for the bistatic sensing between the Tx UE and the Rx UE.

Aspect 29: The method of Aspect 28, wherein the one or more power specifications include one or more of a minimum transmission power, a step power, or a maximum transmission power.

Aspect 30: The method of any of Aspects 28-29, further comprising determining a performance metric of one or more of a first iteration of a sensing signal or a second iteration of a sensing signal transmitted between the Tx UE and the Rx UE.

Aspect 31: The method of Aspect 30, wherein the performance metric includes an indication of a number of detected targets.

Aspect 32: The method of Aspect 30, wherein the performance metric includes a difference between two IoU values.

Aspect 33: The method of Aspect 30, wherein the performance metric includes a difference between IoU values relative to an IoU gradient threshold.

Aspect 34: The method of Aspect 30, wherein the performance metric includes a minimum IoU among detected targets.

Aspect 35: The method of Aspect 30, wherein the performance metric includes a minimum SINR.

Aspect 36: The method of Aspect 30, wherein the performance metric includes a target SINR gradient.

Aspect 37: The method of Aspect 30, wherein the performance metric includes a number of new detected targets.

Aspect 38: The method of Aspect 30, wherein the performance metric includes a negative of MSE of one or more of a range, velocity, angle, or amplitude estimation of a detected target.

Aspect 39: The method of Aspect 30, wherein the performance metric includes a negative MSE gradient of one or more of a range, velocity, angle, or amplitude estimation of a detected target.

Aspect 40: The method of Aspect 30, wherein the performance metric includes one or more of an RSRP, an SINR, an INR, a total interference power, an RSRP path, an SINR path, a target RSRP path, a target SINR path, an interference power statistic, or a clutter power statistic.

Aspect 41: The method of Aspect 30, wherein the performance metric includes a number of bounding boxes detected.

Aspect 42: The method of Aspect 30, wherein the performance metric includes a radar sensing resolution.

Aspect 43: The method of Aspect 30, wherein the performance metric includes a maximum range associated with the first iteration of the sensing signal or the second iteration of the sensing signal.

Aspect 44: An apparatus for wireless communication at a device, comprising a processor; memory coupled with the processor; and instructions stored in the memory and executable by the processor to cause the apparatus to perform the method of one or more of Aspects 1-43.

Aspect 45: A device for wireless communication, comprising a memory and one or more processors coupled to the memory, the one or more processors configured to perform the method of one or more of Aspects 1-43.

Aspect 46: An apparatus for wireless communication, comprising at least one means for performing the method of one or more of Aspects 1-43.

Aspect 47: A non-transitory computer-readable medium storing code for wireless communication, the code comprising instructions executable by a processor to perform the method of one or more of Aspects 1-43.

Aspect 48: A non-transitory computer-readable medium storing a set of instructions for wireless communication, the set of instructions comprising one or more instructions that, when executed by one or more processors of a device, cause the device to perform the method of one or more of Aspects 1-43.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein. a phrase referring to “at least one of” a list of items refers to any combination of those items, including single members. As an example, “at least one of: a, b, or c” is intended to cover a, b, c, a+b, a +c, b +c, and a+b+c, as well as any combination with multiples of the same element (e.g., a+a, a+a+a, a+a+b, a+a+c, a+b+b, a+c+c, b+b, b+b+b, b +b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A transmit (Tx) user equipment (UE) (Tx UE) comprising:
a transceiver;
at least one memory comprising instructions; and
one or more processors, configured to execute the instructions to cause the Tx UE to:
receive, via the transceiver, a resource grant identifying one or more resources for associated with bistatic sensing with a receive (Rx) UE (Rx UE);
transmit, via the transceiver and via the one or more resources identified in the resource grant, a sensing signal in accordance with one or more power specifications; and
receive, via the transceiver, a configuration of a transmit power level, from among the one or more power specifications.

2. The Tx UE of claim 1, wherein the one or more processors are further configured to cause the Tx UE to receive, via the transceiver and from the Rx UE, an indication that the transmit power level of the sensing signal is above a threshold value.

3. The Tx UE of claim 1, wherein the one or more power specifications include one or more of a minimum transmission power, a step power, or a maximum transmission power.

4. The Tx UE of claim 3, wherein transmitting the sensing signal in accordance with the one or more power specifications includes transmitting a first iteration of the sensing signal at the minimum transmission power and transmitting a second iteration of the sensing signal, wherein a power of the second iteration of the sensing signal is increased by the step power relative to the minimum transmission power of the first iteration of the sensing signal.

5. The Tx UE of claim 3, wherein transmitting the sensing signal in accordance with the one or more power specifications includes transmitting a first iteration of the sensing signal at the maximum transmission power and transmitting a second iteration of the sensing signal, wherein a power of the second iteration of the sensing signal is decreased by the step power relative to the maximum transmission power of the first iteration of the sensing signal.

6. The Tx UE of claim 1, wherein the one or more processors are further configured to cause the Tx UE to:
receive, via the transceiver, a bistatic sensing echo,
the one or more power specifications being based at least in part on the bistatic sensing echo.

7. A receive (Rx) user equipment (UE) (Rx UE) comprising:
a transceiver;
at least one memory comprising instructions; and
one or more processors, configured to execute the instructions to cause the Rx UE to:
receive, via the transceiver, a resource grant identifying one or more resources for associated with bistatic sensing with a transmit (Tx) UE (Tx UE);
receive, via the transceiver and via in the one or more resources identified in the resource grant, a sensing signal in accordance with one or more power specifications; and
transmit, via the transceiver and to one or more of the Tx UE or a network entity associated with the Tx UE, an indication that a transmit power level of the sensing signal is above a threshold.

8. The Rx UE of claim 7, wherein the one or more power specifications include one or more of a minimum transmission power, a step power, or a maximum transmission power.

9. The Rx UE of claim 8, wherein receiving the sensing signal in accordance with the one or more power specifications includes receiving a first iteration of the sensing signal at the minimum transmission power and receiving a second iteration of the sensing signal, wherein a power of the second iteration of the sensing signal is increased by the step power relative to the minimum transmission power of the first iteration of the sensing signal.

10. The Rx UE of claim 9, wherein the one or more processors are further configured to determine a performance metric of one or more of the first iteration of the sensing signal or the second iteration of the sensing signal.

11. The Rx UE of claim 10, wherein one of:
the performance metric includes an indication of a number of detected targets;
the performance metric includes a difference between two intersection over union (IoU) values;
the performance metric includes a difference between IoU values relative to an IoU gradient threshold;
the performance metric includes a minimum IoU among one or more detected targets;
the performance metric includes a minimum signal to interference plus noise ratio (SINR); and
the performance metric includes a target SINR gradient.

12-16. (canceled)

17. The Rx UE of claim 10, wherein the performance metric includes a number of new detected targets.

18. The Rx UE of claim 10, wherein the performance metric includes a negative of mean square error (MSE) of one or more of a range, velocity, angle, or amplitude estimation of a detected target.

19. The Rx UE of claim 10, wherein the performance metric includes a negative mean square error (MSE) gradient of one or more of a range, velocity, angle, or amplitude estimation of a detected target.

20. The Rx UE of claim 10, wherein the performance metric includes one or more of a reference signal received power (RSRP), a signal to interference noise ratio (SINR), an interference to noise ratio (INR), a total interference power, an RSRP path, an SINR path, a target RSRP path, a target SINR path, an interference power statistic, or a clutter power statistic.

21. The Rx UE of claim 8, wherein receiving the sensing signal in accordance with the one or more power specifications includes receiving a first iteration of the sensing signal at the maximum transmission power and receiving a second iteration of the sensing signal, wherein a power of the second iteration of the sensing signal is decreased by the step power relative to the maximum transmission power of the first iteration of the sensing signal.

22. The Rx UE of claim 21, wherein the one or more processors are further configured to determine a performance metric of one or more of the first iteration of the sensing signal or the second iteration of the sensing signal.

23. The Rx UE of claim 22, wherein one of:
the performance metric includes a number of bounding boxes detected;
the performance metric includes a radar sensing resolution; and
the performance metric includes a maximum range associated with the first iteration of the sensing signal or the second iteration of the sensing signal.

24-25. (canceled)

26. The Rx UE of claim 7, wherein the one or more processors are further configured to cause the Rx UE to receive, via the transceiver, the one or more power specifications, and wherein the one or more processors are further configured to transmit, via the transceiver, a bistatic sensing echo in response to the sensing signal and in accordance with the one or more power specifications.

27. A method of wireless communication performed by a transmit (Tx) user equipment (UE) (Tx UE), comprising:
receiving a resource grant identifying one or more resources for bistatic sensing with a receive (Rx) UE (Rx UE);
transmitting, in the one or more resources identified in the resource grant, a sensing signal in accordance with one or more power specifications; and
receiving a configuration of a transmit power level, from among the one or more power specifications, for bistatic sensing with the Rx UE.

28-30. (canceled)
